(19) United States
(12) Patent Application Publication
(10) Pub. No.: US 2020/0341296 A1
(43) Pub. Date: Oct. 29, 2020

(54) ASPHERIC LENS CAPABLE OF USING MONOCULAR RETINAL RIVALRY TO CONTROL AXIAL LENGTH GROWN RATE

(71) Applicant: BRIGHTEN OPTIX CORP., Taipei (TW)

(72) Inventors: I-Tsung WU, Taipei (TW); Wen-Pin LIN, Taipei (TW)

(21) Appl. No.: 16/925,693

(22) Filed: Jul. 10, 2020

Related U.S. Application Data
(63) Continuation-in-part of application No. 16/158,833, filed on Oct. 12, 2018.

(30) Foreign Application Priority Data
Nov. 17, 2017 (TW) 106217150

(51) Int. Cl. G02C 7/04; G02C 7/02

(52) U.S. Cl. CPC G02C 7/04; G02C 2202/24; G02C 7/028

(57) ABSTRACT

An aspheric lens capable of using monocular retinal rivalry effect to control axial length grown rate is disclosed. The aspheric lens includes an optical area for making retina of a wearer's eyeball occur monocular retinal rivalry phenomenon. When the lens is worn on the wearer's eyeball, the retina of eyeball can occur monocular retinal rivalry phenomenon, so that eyeball growth rate can be controlled by monocular retinal rivalry phenomenon, thereby effectively slowing myopia or hyperopia progression, to achieve the effect of correcting and improving myopia or hyperopia.

This application is a Continuation-In-Part of co-pending application Ser. No. 16/158,833, filed on Oct. 12, 2018, for which priority is claimed under 35 U.S.C. § 120, the entire contents of which are hereby incorporated by reference.

This application claims the priority benefit of Application No. 106217150 filed in Taiwan on Nov. 17, 2017.

### BACKGROUND OF THE INVENTION

### 1. Field of the Invention

The present invention relates to an aspheric lens capable of using monocular retinal rivalry effect to control axial length grown rate. More particularly, when the aspheric lens of the present invention is worn on a wear's eyeball, the optical area of the lens can make retina of the eyeball occur monocular retinal rivalry phenomenon, so as to control the eyeball growth rate to effectively slow myopia or hyperopia progression, thereby achieving the effect of correcting and improving myopia or hyperopia.

### 2. Description of the Related Art

Myopia and hyperopia can seriously affect a person's ability in acting normally without vision assistance, and high myopia also increases the risk of suffering from eye diseases, for example, high myopia will increase risk of suffering from retinopathy, cataract or glaucoma.

In order to correct myopia or hyperopia, it is necessary to wear spectacles or contact lenses to correct vision, so as to move focus forwardly or backwardly to retina to form a clearer image, thereby solving the problem caused by myopia or hyperopia. However, while wearing conventional spectacles or contact lenses can correct nearsightedness or farsightedness, but it cannot control the amount or rate of myopia or hyperopia progression.

Therefore, what we need is to develop a novel lens to solve the aforementioned conventional drawback and inconvenience.

### SUMMARY OF THE INVENTION

In order to solve aforementioned drawbacks, the inventors develop an aspheric lens capable of using monocular retinal rivalry to control axial length grown rate according to collected data, multiple tests and modifications, and years of experience in the industry.

An objective of the present invention is to provide an aspheric lens including an optical area for making a wearer's retina occur monocular retinal rivalry phenomenon; and when the aspheric lens of the present invention is worn on a wearer's eyeball, of the wearer's retina can occur monocular retinal rivalry phenomenon, so that an eyeball growth rate can be controlled by monocular retinal rivalry phenomenon, thereby effectively slowing myopia or hyperopia progression, to achieve the purpose of correcting and improving myopia or hyperopia.

### BRIEF DESCRIPTION OF THE DRAWINGS

The structure, operating principle and effects of the present invention will be described in detail by way of various embodiments which are illustrated in the accompanying drawings.

FIG. 1 is a schematic plan view of the present invention.

FIG. 2 is an optical path diagram of a lens generating an image with a clear central part and a blur peripheral part, according to the present invention.

FIG. 3 is an optical path diagram of a lens generating an image with a blur central part and a clear peripheral part, according to the present invention.

FIG. 4 is an optical path diagram of a lens generating an image with a clear central part and a blur peripheral part, according to the present invention.

FIG. 5 is an optical path diagram of a lens generating an image with a blur central part and a clear peripheral part, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

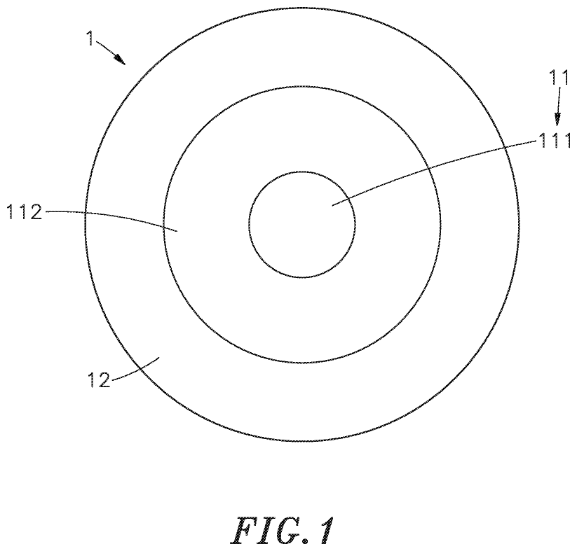

Please refer to FIGS. 1 to 3, which are a schematic plan view of the present invention, an optical path diagram of a lens generating an image with a clear central part and a blur peripheral part, and an optical path diagram of a lens generating a blur central part and a clear peripheral part. As shown in FIGS. 1 to 3, a lens 1, such as a lens 1 of a contact lens or a lens 1 of a spectacles, can include an optical area 11 for making retina 21 of a wearer's eyeball 2 occur monocular retinal rivalry phenomenon. The optical area 11 includes a central optical area 111 formed on a central part thereof and for passing light to image on a central imaging area 211 (such as macula) of the retina 21, and a peripheral optical area 112 formed around a periphery of the central optical area 111 and for imaging on a peripheral imaging area 212 around the central imaging area 211. The peripheral imaging area 212 surrounds a periphery of the macula. The lens 1 also includes a blind area 12 formed around an outer side of the optical area 11, and the blind area 12 is a non-visual area. The central imaging area 211 includes a central clear-imaging area 2111 for focusing light to form a clear image, and a central image blurring area 2112 for forming a defocus image on the outside of the central clear-imaging area 2111; furthermore, the peripheral imaging area 212 includes a peripheral clear-imaging area 2121 for focusing light to form a clear image, and a peripheral image blurring area 2122 for forming a defocus image on the outside of the peripheral clear-imaging area 2121.

When in practical use, the lens 1 can be worn on the wearer's eyeball 2, so that light can be passed through the optical area 11 of the lens 1 to emit on the retina 21 behind the eyeball 2, and the light passing through the central optical area 111 and the peripheral optical area 112 of the optical area 11 can image on the central imaging area 211 and the peripheral imaging area 212 of the retina 21, respectively; and at this time, a ratio of an imaging area on the central imaging area 211 and an imaging area on the peripheral imaging area 212 of the retina 21 is in a preset range in which the retina 21 occurs monocular retinal rivalry phenomenon, so that the optical area 11 of the lens 1 can be used to make the retina 21 occur monocular retinal rivalry phenomenon which can control axial length grown rate, thereby effectively slowing or retarding progression of myopia or hyperopia, to further achieve myopia or hyperopia correction effect.

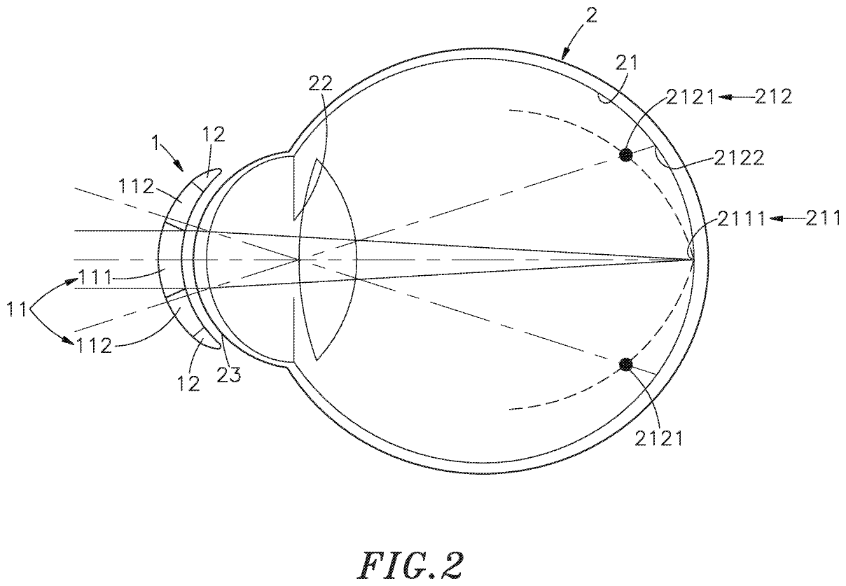

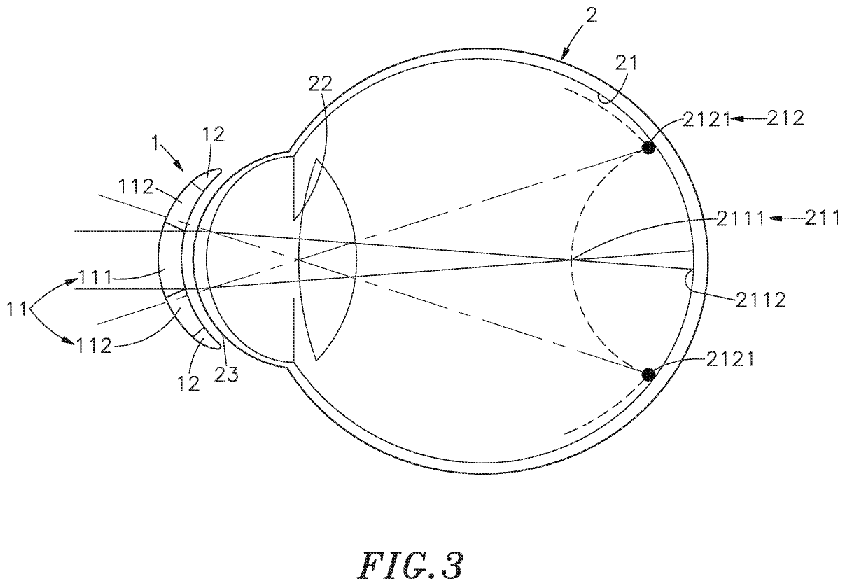

There are two types of lens 1 to make the retina 21 of the eyeball 2 occur monocular retinal rivalry phenomenon. In the first type of lens 1, as shown in FIG. 2, light is focused on the retina 21, the central clear-imaging area 2111 of the central imaging area 211 can be formed on a central part of the retina 21, and the peripheral image blurring area 2122 of the peripheral imaging area 212 can further be formed on a peripheral of the central clear-imaging area 2111, so as to generate the image with a clear central part and a blur peripheral part. In the second type of lens 1, as shown in FIG. 3, light is focused on the peripheral of the retina 21, the central image blurring area 2112 of the central imaging area 211 can be formed on a central part of the retina 21, and the peripheral clear-imaging area 2121 of the peripheral imaging area 212 can further be formed on a peripheral of the central image blurring area 2112, so as to generate the image with a blur central part and a clear peripheral part. Both of the two aforementioned types of lenses 1 can make the retina 21 occur monocular retinal rivalry phenomenon to correct myopia or hyperopia.

Preferably, the imaging area on the central imaging area 211 of the retina 21 is smaller than the imaging area on the peripheral imaging area 212; however, in actual application, the ratio of the imaging area on the central imaging area 211 of the retina 21 and the imaging area on the peripheral imaging area 212 of the retina 21 can be in a preset range of 10% to 40%, so as to make the retina 21 of the eyeball 2 effectively occur monocular retinal rivalry phenomenon.

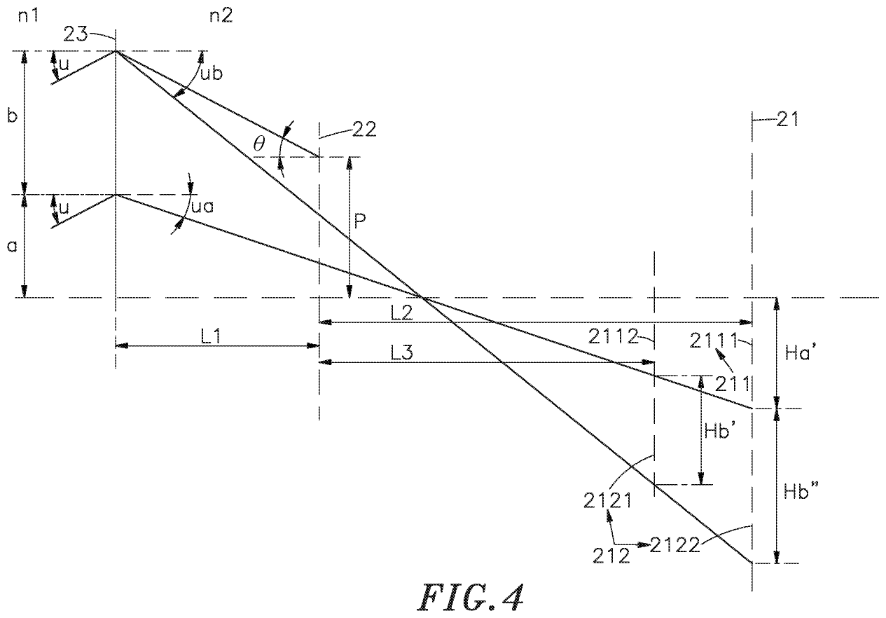

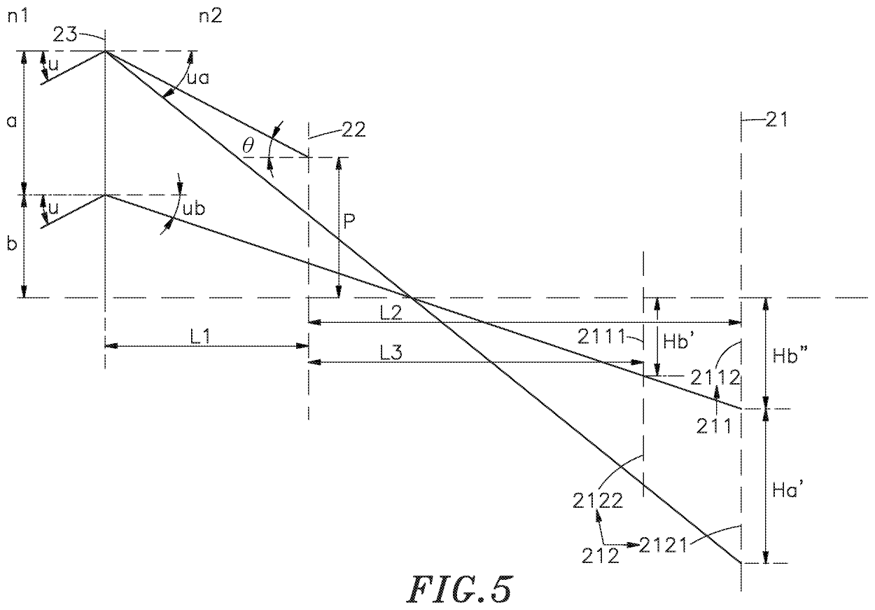

Please refer to FIGS. 4 and 5, which are an optical path diagram of a lens generating an image with a clear central part and a blur peripheral part and an optical path diagram of the lens generating an image with a blur central part and a clear peripheral part, according to the present invention. As shown in FIGS. 4 and 5, in order to enable the lens 1 of the present invention to generate the image with the clear central part and the blur peripheral part, the ratio of the imaging area on the central imaging area 211 and the imaging area on the peripheral imaging area 212 of the retina 21 can be calculated based on following equation:

$$\frac{{π ( {H}_{a}^{′} )}^{2}}{{π ( {H}_{a}^{′} + {H}_{b}^{″} )}^{2} - {π ( {H}_{a}^{′} )}^{2}}$$

Hₐ′: an image radius of the central clear-imaging area 2111; and H_{b}″: an image radius of the peripheral image blurring area 2122.

The image radius (Hₐ′) of the central clear-imaging area 2111 can be calculated based on following equation:

Hₐ′=(L₁+L₂)−tan(uₐ)−a

uₐ: a light emergence angle of the central optical area 111; a: a radius of the central optical area 111; L₁: a distance between the cornea 23 and the pupil 22; and L₂: a distance between the pupil 22 and the retina 21.

The image radius (H_{b}″) of the peripheral image blurring area 2122 can be calculated based on a relationship equation of blur image and exit pupil:

H_{b}″=(L₂/L₃)H_{b}′

L₂: a distance between the pupil 22 and the retina 21; L₃: an imaging distance between the pupil 22 to the peripheral clear-imaging area 2121; and H_{b}′: an image radius of the peripheral clear-imaging area 2121.

The image radius (H_{b}′) of the peripheral clear-imaging area 2121 can be calculated based on following equation:

H_{b}′=(L₁+L₃)[tan(u_{b})−tan(uₜ)]−L₁ tan θ−p+a

uₐ: a light emergence angle of the central optical area 111; u_{b}: a light emergence angle of the peripheral optical area 112; p: radius of the pupil 22; θ: an angle of view field; L₁: a distance between the cornea 23 and the pupil 22; and L₃: an imaging distance between the pupil 22 to the peripheral clear-imaging area 2121.

Furthermore, the equation of the ratio of the imaging area on the central imaging area 211 and the imaging area on the peripheral imaging area 212 of the retina 21 can be obtained by substituting aforementioned equations, as following:

[(L₁+L₂)tan((n₁u−acₐ(n₂−n₁))/n₂)−a]\hat{ }2/(2[(L₁+L₂)tan((n₁u−acₐ(n₂−n₁))/n₂)−a][(L₂/L₃)[(L₁+L₃)[tan((n₁u−(L₁ tan θ+p)c_{b}(n₂−n₁))/n₂)−tan((n₁u−acₐ(n₂−n₁))/n₂)]]+((L₂/L₃)[(L₁+L₃)[tan((n₁u−(L₁ tan θ+p)c_{b}(n₂−n₁))/n₂)−tan((n₁u−acₐ(n₂−n₁))/n₂)]−L₁ tan θ−p+a])\hat{ }2)

The value of the above equation:

p: a radius of the pupil 22; θ: an angle of view field; a: a radius of the central optical area 111; n₁: a refractive index between the lens 1 and the viewed object; n₂: a refractive index between the lens 1 and the pupil 22; u: an incident angle of the light emitted on an edge; cₐ: a curvature of the central optical area 111; c_{b}: a curvature of the peripheral optical area 112; L₁: a distance between the cornea 23 and the pupil 22; L₂: a distance between the pupil 22 and the retina 21; and L₃: an imaging distance between the pupil 22 to the peripheral clear-imaging area 2121.

In order to enable the lens 1 of the present invention to generate the image with a blur central part and a clear peripheral part, the ratio of the imaging area on the central imaging area 211 and the imaging area on the peripheral imaging area 212 of the retina 21 can be calculated based on following equation:

$$\frac{{π ( {H}_{b}^{″} + {H}_{a}^{′} )}^{2} - {π ( {H}_{b}^{″} )}^{2}}{{π ( {H}_{b}^{″} )}^{2}}$$

Hₐ′: an image radius of the peripheral clear-imaging area 2121; and H_{b}″: an image radius of the central image blurring area 2112.

The peripheral clear-imaging area 2121 (Hₐ′) can be calculated based on following equation:

Hₐ′=(L₁+L₂)[tan(uₐ)−tan(u_{b})]−L₁ tan θ−p+b

uₐ: a light emergence angle of the peripheral optical area 112; u_{b}: a light emergence angle of the central optical area 111; b: a radius of the central optical area III; L₁: a distance between the cornea 23 and the pupil L₂: a distance between the pupil 22 and the retina 21; p: a radius of the pupil 22; and θ: an angle of view field.

The image radius (H_{b}″) of the central image blurring area 2112 can be calculated based on the relationship equation of blur image and exit pupil:

H_{b}″=(L₂/L₃)H_{b}′

L₂: a distance between the pupil 22 and the retina 21; L₃: an imaging distance between the pupil 22 and the central image blurring area 2112; and H_{b}′: an image radius of the central clear-imaging area 2111.

The image radius (H_{b}′) of the central clear-imaging area 2111 can be calculated based on following equation:

H_{b}′=(L₁+L₃)tan(u_{b})−b

u_{b}: a light emergence angle of the central optical area 111; b: a radius of the central optical area 111; L₁: a distance between the cornea 23 and the pupil 22; and L₃: an imaging distance between the pupil 22 to the central clear-imaging area 2111.

Furthermore, the equation of the ratio of the imaging area on the central imaging area 211 and the imaging area on the peripheral imaging area 212 of the retina 21 can be obtained by substituting aforementioned equations, as following:

(2((L₂/L₃)(L₁+L₃)tan((n₁u−bc_{b}(n₂−n₁))/n₂)−b))((L₁+L₂)[tan((n₁u−(L₁ tan θ+p)cₐ(n₂−n₁))/n₂)−tan((n₁u−bc_{b}(n₂−n₁))/n₂)]−L₁ tan θ−p+b)+((L₁+L₂)[tan((n₂u−(L₁ tan θ+p)cₐ(n₂−n₁))/n₂)−tan((n₁u−bc_{b}(n₂−n₁))/n₂)]−L₁ tan θ−p+b)\hat{ }2)/((L₂/L₃)((L₁+L₃)tan((n₁u−bc_{b}(n₂−n₁))/n₂)−b))\hat{ }2

The value of the above equation:

p: a radius of the pupil 22; θ: an angle of view field; a: a radius of the peripheral optical area 112; n₁: a refractive index between the lens 1 and the viewed object; n₂: a refractive index between the lens 1 and the pupil 22; u: an incident angle of the light emitted on an edge; cₐ: a curvature of the peripheral optical area 112; c_{b}: a curvature of the central optical area 111; L₁: a distance between the cornea 23 and the pupil 22; L₂: a distance between the pupil 22 and the retina 21; and L₃: an imaging distance between the pupil 22 to the central clear-imaging area 2111.

The above-mentioned content is just a preferred embodiment, and claim scope of the present invention is not limited thereto. The key concept of the present invention is that the optical area 11 of the lens 1 worn on the eyeball 2 can make the retina 21 of the eyeball 2 occur monocular retinal rivalry phenomenon, so as to control a growth rate of the eyeball 2, thereby effectively slowing myopia or hyperopia progression, to achieve the effect of correcting and improving myopia or hyperopia. Various equivalent structural changes, alternations or modifications based on the descriptions and figures of present invention are all consequently viewed as being embraced by the spirit and the scope of the present invention set forth in the claims.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An aspheric lens capable of using monocular retinal rivalry to control axial length grown rate, and comprising an optical area for making retina of a wearer's eyeball occur monocular retinal rivalry phenomenon.

2. The aspheric lens according to claim 1, wherein the aspheric lens is a lens of a contact lens or a lens of a spectacles.

3. The aspheric lens according to claim 1, wherein the optical area of the aspheric lens comprises a central optical area formed on a central part thereof and for passing light to image on a central imaging area of the retina, and a peripheral optical area surrounding a periphery of the central optical area and for passing light to image on a peripheral imaging area around the central imaging area, and a ratio of an imaging area on the central imaging area of the retina and an imaging area on the peripheral imaging area of the retina is in a range, in which the retina occurs monocular retinal rivalry phenomenon.

4. The aspheric lens according to claim 3, wherein the imaging area on the central imaging area of the retina is smaller than the imaging area on the peripheral imaging area of the retina.

5. The aspheric lens according to claim 3, wherein the ratio of the imaging area on the central imaging area of the retina and the imaging area on the peripheral imaging area of the retina is in a range of 10% to 40%.

6. The aspheric lens according to claim 3, wherein the central imaging area comprises a central clear-imaging area formed on a central part of the retina, and a central image blurring area formed in front of the retina, and the peripheral imaging area comprises a peripheral image blurring area formed on the retina, and a peripheral clear-imaging area formed in front of the retina.

7. The aspheric lens according to claim 6, wherein when light is focused on the central clear-imaging area of the central imaging area to form an image with a clear central part and a blur peripheral part, the ratio of the imaging area on the central imaging area of the retina and the imaging area on the peripheral imaging area of the retina is calculated based on an equation:
$$\frac{{π ( {H}_{a}^{′} )}^{2}}{{π ( {H}_{a}^{′} + {H}_{b}^{″} )}^{2} - {π ( {H}_{a}^{′} )}^{2}}$$
wherein Hₐ′ is an image radius of the central clear-imaging area, and H_{b}″ is an image radius of the peripheral image blurring area.

8. The aspheric lens according to claim 3, wherein the central imaging area comprises a central image blurring area formed on a central part of the retina, and a central clear-imaging area formed in front of the retina, and the peripheral imaging area comprises a peripheral clear-imaging area formed on the retina, and a peripheral image blurring area formed in front of the retina.

9. The aspheric lens according to claim 8, wherein when light is focused on the peripheral clear-imaging area of the peripheral imaging area to form an image with a blur central part and a clear peripheral part, the ratio of the imaging area on the central imaging area and the imaging area on the peripheral imaging area of the retina is calculated based on an equation:
$$\frac{{π ( {H}_{b}^{″} + {H}_{a}^{′} )}^{2} - {π ( {H}_{b}^{″} )}^{2}}{{π ( {H}_{b}^{″} )}^{2}}$$
wherein Hₐ′ is an image radius of the peripheral clear-imaging area, and H_{b}″ is an image radius of the central image blurring area.

10. The aspheric lens according to claim 1, further comprising a blind area formed around an outer side of the optical area, wherein the blind area is a non-visual area.
